(19) United States
(12) Patent Application Publication
(10) Pub. No.: US 2023/0150063 A1
(43) Pub. Date: May 18, 2023

(54) LASER-GAS HYBRID CUTTING SYSTEM

(71) Applicant: Hanto cutting system co.,ltd., Gimhae-si (KR)

(72) Inventors: Il Woo MOON, Gimhae-si (KR); Do Yeong MUN, Changwon-si (KR)

(21) Appl. No.: 17/969,811

(22) Filed: Oct. 20, 2022

(30) Foreign Application Priority Data
Nov. 12, 2021 (KR) 10-2021-0155268

(51) Int. Cl. B23K 26/14; B23K 26/38; B23K 26/082

(52) U.S. Cl. CPC B23K 26/14; B23K 26/38; B23K 26/082

(57) ABSTRACT

Disclosed herein is a laser-gas hybrid cutting system. The laser-gas hybrid cutting system includes: a first cutting means coupled to a gantry or arm, provided to be transferable, and configured to enable the cutting of a workpiece using a laser; and a second cutting means provided on one side of the first cutting means so that an angle or distance can be varied with respect to a workpiece, and configured to enable the cutting of a workpiece using a gas together with the first cutting means. In this case, the gas used in the second cutting means is any one of hydrogen, oxygen, liquefied petroleum gas, and liquefied natural gas.

### CROSS-REFERENCE TO RELATED APPLICATION

This application claims the benefit of Korean Patent Application No. 10-2021-0155268 filed on Nov. 12, 2021 which is hereby incorporated by reference herein in its entirety.

### BACKGROUND

### 1. Technical Field

The present invention relates generally to a laser-gas hybrid cutting system, and more particularly to a laser-gas hybrid cutting system in which a first cutting means and a second cutting means are configured to form different axes, so that optimum machining conditions can be provided for the first cutting means and the second cutting means, respectively, and in which a workpiece is cut through the first cutting means and the second cutting means, so that cutting efficiency can be improved.

### 2. Description of the Related Art

In general, cutting machines are apparatuses for cutting a workpiece by removing part of the workpiece.

Such cutting machines include gas cutting machines using oxygen, liquefied petroleum gas (LPG), or acetylene gas, plasma cutting machines using a plasma jet, and laser cutting machines using the thermal energy of laser light.

Gas cutting machines are suitable when the thickness of a workpiece is thick, but has the disadvantage of slow machining. Plasma cutting machines and laser cutting machines are capable of high-speed cutting, but have the disadvantage of not being suitable when the thickness of a workpiece is thick.

In connection with this, Korean Patent No. 10-2071136 discloses a hybrid cutting apparatus that cuts a workpiece by simultaneously radiating a high-pressure oxygen flame and a laser beam onto the workpiece.

However, the prior art hybrid cutting apparatus has a problem in that interference occurs between a high-pressure oxygen flame and a laser beam because an oxygen cutting torch for radiating a high-pressure oxygen flame and a laser torch for radiating a laser beam are formed coaxially.

Furthermore, the prior art hybrid cutting apparatus has another problem in that since the oxygen cutting torch and the laser torch are formed coaxially, it is difficult to provide machining conditions suitable for oxygen cutting and laser cutting, respectively.

### SUMMARY

The present invention has been conceived to overcome the above-described problems, and an object of the present invention is to provide a laser-gas hybrid cutting system in which a first cutting means and a second cutting means are configured to form different axes, so that optimum machining conditions can be provided for the first cutting means and the second cutting means, respectively, and in which a workpiece is cut through the first cutting means and the second cutting means, so that cutting efficiency can be improved.

In order to accomplish the above object, the present invention provides a laser-gas hybrid cutting system, including: a first cutting means coupled to a gantry or arm, provided to be transferable, and configured to enable the cutting of a workpiece using a laser; and a second cutting means provided on one side of the first cutting means so that an angle or distance can be varied with respect to a workpiece, and configured to enable the cutting of a workpiece using a gas together with the first cutting means; wherein the gas used in the second cutting means is any one of hydrogen, oxygen, liquefied petroleum gas, and liquefied natural gas.

The second cutting means may include: a first body provided to be spaced apart from the first cutting means to one side of the first cutting means; a first guide part provided on one side of the first body, and configured to allow a second cutting part to be transferred along the radius of curvature thereof; and the second cutting part provided to be transferable from one side of the first guide part to the other side of the first guide part, and configured to enable the cutting of a workpiece using a gas.

The first guide part may include: a first guide member provided on one side of the first body and provided with a first rack portion therein so that the first guide member can guide a first transfer member through its transfer; the first transfer member provided on one side of the first guide member, and configured to be transferred along the inside of the first guide member by the rotation of a first adjustment member; and the first adjustment member provided on one side of the first transfer member and provided to be rotatable inside the first guide member so that the first transfer member can be transferred.

The second cutting part may include: a second body provided on one side of the first transfer member, and provided with a second guide portion therein; a second cutting member provided inside the second body and provided with a second rack portion on one surface thereof so that the second cutting member can be transferred along the inside of the second guide portion by the rotation of a second adjustment member and enables the cutting of a workpiece using a gas; and the second adjustment member provided on one side of the second body and rotatably provided inside the second body so that it enables the transfer of the second cutting member.

The point at which laser machining is performed by the first cutting means may be located inside the point at which gas machining is performed by the second cutting means.

The laser-gas hybrid cutting system according to the present invention has the following advantages:

In the laser-gas hybrid cutting system according to the present invention, the first cutting means and the second cutting means are provided, and the first cutting means and the second cutting means cut a workpiece together, so that there is an advantage in that cutting efficiency can be improved.

In the laser-gas hybrid cutting system according to the present invention, the second cutting member constituting a part of the second cutting means is provided to enable the adjustment of an angle with respect to a workpiece and the distance to the workpiece, so that there is an advantage in that machining conditions optimized for the first cutting means and the second cutting means, respectively, can be provided.

In the laser-gas hybrid cutting system according to the present invention, the second cutting means uses hydrogen fuel-oxygen gas, so that there is an advantage in that cutting speed is improved and a reduction in the number of kerfs can be achieved.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing the configuration of an embodiment of a laser-gas hybrid cutting system according to the present invention;

FIG. 2 is a front view showing the configuration of the embodiment of the laser-gas hybrid cutting system according to the present invention;

FIG. 3 is a rear view showing the configuration of the embodiment of the laser-gas hybrid cutting system according to the present invention;

FIG. 4 is a sectional view showing the configuration of a first guide part constituting a part of the embodiment of the laser-gas hybrid cutting system according to the present invention; and

FIG. 5 is a sectional view showing the configuration of a second cutting part constituting a part of the embodiment of the laser-gas hybrid cutting system according to the present invention.

### DETAILED DESCRIPTION

An embodiment of a laser-gas hybrid cutting system according to the present invention will be described in detail below with reference to the accompanying drawings.

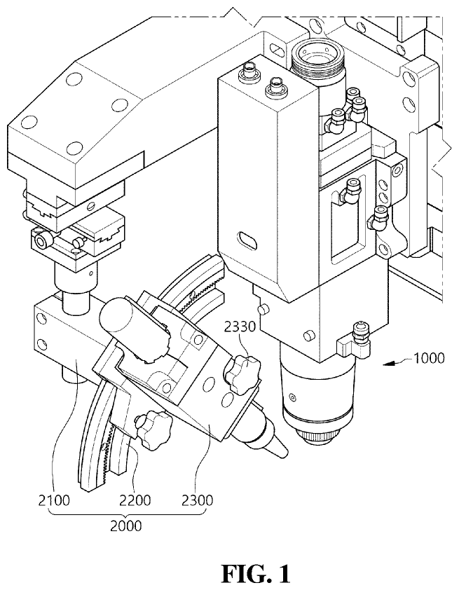

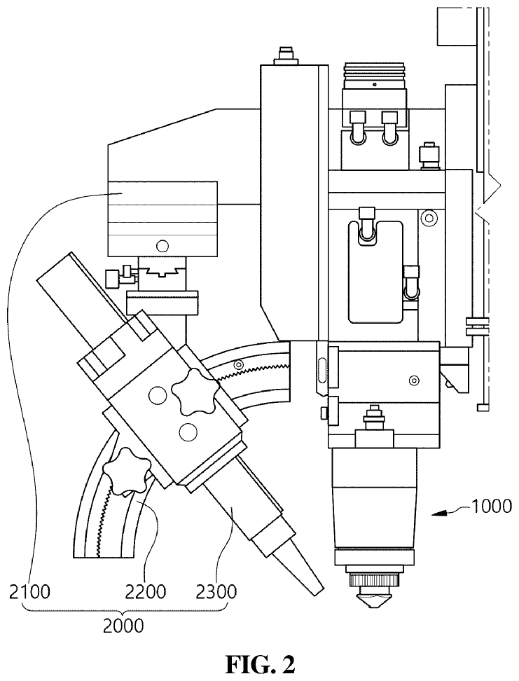

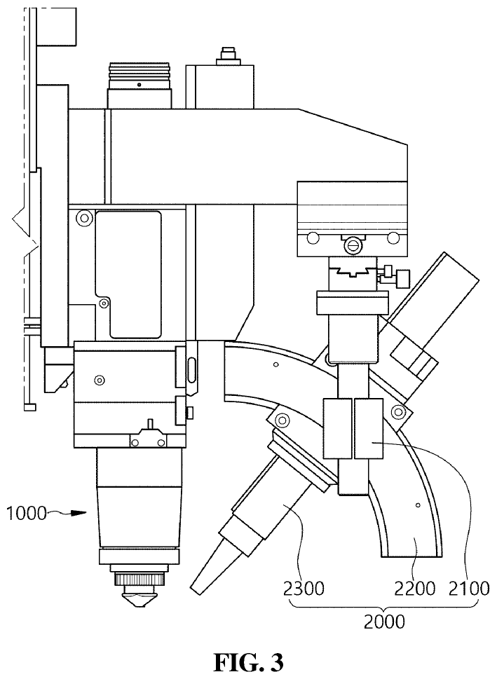

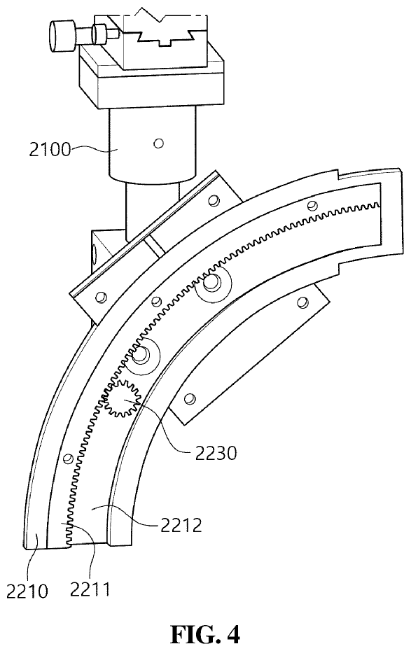

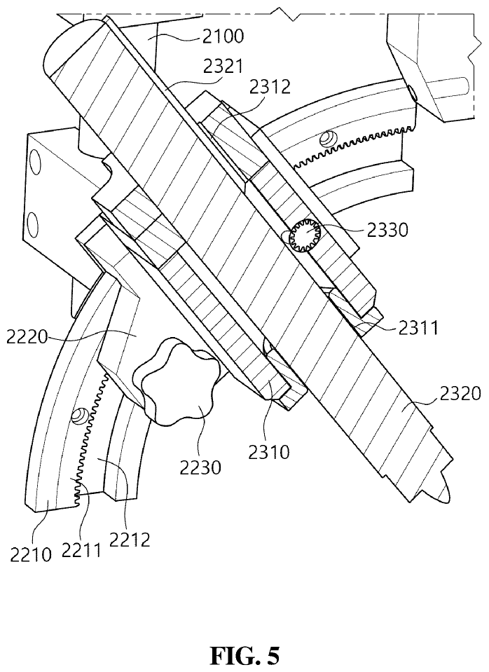

Referring to FIGS. 1 to 5, the embodiment of the laser-gas hybrid cutting system according to the present invention is shown. In more detail, FIG. 1 is a perspective view showing the configuration of the embodiment of the laser-gas hybrid cutting system according to the present invention, FIG. 2 is a front view showing the configuration of the embodiment of the laser-gas hybrid cutting system according to the present invention, FIG. 3 is a rear view showing the configuration of the embodiment of the laser-gas hybrid cutting system according to the present invention, FIG. 4 is a sectional view showing the configuration of a first guide part constituting a part of the embodiment of the laser-gas hybrid cutting system according to the present invention, and FIG. 5 is a sectional view showing the configuration of a second cutting part constituting a part of the embodiment of the laser-gas hybrid cutting system according to the present invention.

As shown in these drawings, the laser-gas hybrid cutting system according to the present invention includes: a first cutting means 1000 coupled to a gantry or arm, provided to be transferable, and configured to enable the cutting of a workpiece using a laser; and a second cutting means 2000 provided on one side of the first cutting means 100 so that an angle or distance can be varied with respect to a workpiece, and configured to enable the cutting of a workpiece using a gas together with the first cutting means 100.

The gantry (not shown) is configured to be coupled to the first cutting means 1000 or the second cutting means 2000 so that the first cutting means 1000 or the second cutting means 2000 can be transferred.

The gantry enables the first cutting means 1000 or the second cutting means 2000 to be moved forward, backward, left, right, up, and down.

In addition, the aim (not shown) is configured to be coupled to the first cutting means 1000 or the second cutting means 2000 like a gantry so that the first cutting means 1000 or the second cutting means 2000 can be transferred.

The aim includes multiple joints, so that the first cutting means 1000 or the second cutting means 2000 can be moved forward, backward, left, right, up, and down.

In other words, the first cutting means 1000 or the second cutting means 2000 is configured to be coupled to the gantry or aim and to be transferred at least forward, backward, left, right, up, and down.

The first cutting means 1000 is configured to be coupled to the gantry or aim and to cut a workpiece (e.g., an iron plate) while being transferred forward, backward, left, right, up, and/or down.

The first cutting means 1000 is configured to enable the cutting of a workpiece using a laser.

In addition, the first cutting means 1000 may also use an assist gas for laser cutting, in which case the assist gas is oxygen or nitrogen as an example.

The second cutting means 2000 is provided on the left side of the above-described first cutting means 1000 (in FIG. 2).

The second cutting means 2000 is coupled to the gantry or aim or the first cutting means 1000, and is provided to be spaced apart from the gantry or arm or the first cutting means 1000 in the leftward direction (in FIG. 2).

The second cutting means 2000 is configured to cut a workpiece while being transferred forward, backward, left, right, up, and/or down together with the first cutting means 1000.

The above-described second cutting means 2000 is configured to enable the cutting of a workpiece using a gas.

The second cutting means 2000 includes: a first body 2100 provided to be spaced apart from the first cutting means 1000 to one side of the first cutting means 1000; a first guide part 2200 provided on one side of the first body 2100, and configured to allow a second cutting part 2300 to be transferred along the radius of curvature thereof; and the second cutting part 2300 provided to be transferable from one side of the first guide part 2200 to the other side of the first guide part 2200, and configured to enable the cutting of a workpiece using a gas.

The first body 2100 is provided to extend from the gantry or arm or the first cutting means 1000, and is preferably located on the left side of the first cutting means 1000 (in FIG. 2).

The above-described first body 2100 is configured to enable the support of the second cut part 2300.

The first guide part 2200 is provided on the front side of the first body 2100 (in FIG. 1).

The first guide part 2200 includes: a first guide member 2210 provided on one side of the first body 2100 and provided with a first rack portion 2211 therein so that the first guide member 2210 can guide a first transfer member 2220 through its transfer; the first transfer member 2220 provided on one side of the first guide member 2210, and configured to be transferred along the inside of the first guide member 2210 by the rotation of a first adjustment member 2230; and the first adjustment member 2230 provided on one side of the first transfer member 2220 and provided to be rotatable inside the first guide member 2210 so that the first transfer member 2220 can be transferred.

The first guide member 2210 is provided on the front side of the first body 2100, and is formed in an arc shape.

A coupling groove 2212 configured such that the first adjustment member 2230 is inserted thereinto is formed in the first guide member 2210, and also the first rack portion 2211 configured to allow the first transfer member 2220 to be transferred by the rotation of the first adjustment member 2230 is formed in the coupling groove 2212.

As the first guide member 2210 is formed in an arc shape and the first rack portion 2211 is formed therein as described above, the first transfer member 2220 may be rotated and transferred while forming an arc along the first guide member 2210.

In addition, the first transfer member 2220 is provided on the front side of the first guide member 2210.

The first transfer member 2220 is a portion that is rotated and transferred while forming an arc along the first guide member 2210 by the rotation of the first adjustment member 2230, and is configured to support the second cutting part 2300.

The above-described first transfer member 2220 is a portion that is formed in a shape similar to the shape of a flat plate and coupled to the first guide member 2210 so that it can be transferred along the first guide member 2210.

In addition, the first adjustment member 2230 is provided on the first transfer member 2220.

The first adjustment member 2230 is provided to penetrate the first transfer member 2220 from the front side of the first transfer member 2220 to the back side thereof. The first adjustment member 2230 is configured such that the front end thereof is implemented as a handle configured to allow a user to perform rotation while the back end thereof is formed as a pinion configured to be coupled to the first rack portion 2211 and allow transfer along the coupling groove 2212.

In other words, according to the clockwise or counterclockwise rotation of the first adjustment member 2230, the first adjustment member 2230 may be transferred along the inside of the first rack portion 2211, and accordingly, the first transfer member 2220 is also transferred.

The rotational transfer of the second cutting part 2300 is enabled by the first guide part 2200 configured as described above, through which the angle of the second cutting part 2300 with respect to a workpiece can be adjusted.

In addition, the second cutting part 2300 is provided on the front side of the first guide part 2200.

The second cutting part 2300 includes: a second body 2310 provided on one side of the first transfer member 2220, and provided with a second guide portion 2311 therein; a second cutting member 2320 provided inside the second body 2310 and provided with a second rack portion 2321 on one surface thereof so that it is transferred along the inside of the second guide portion 2311 by the rotation of a second adjustment member 2330 and enables the cutting of a workpiece using a gas; and the second adjustment member 2330 provided on one side of the second body 2310 and rotatably provided inside the second body 2310 so that it enables the transfer of the second cutting member 2320.

The second body 2310 is provided on the front side of the first transfer member 2220, and is formed in a shape similar to the shape of a hexahedron.

The above-described second body 2310 is configured such that it can support the second cutting member 2320 while being rotated and transferred in an arc form together with the first transfer member 2220.

In addition, the second guide portion 2311 is formed on the second body 2310.

The second guide portion 2311 is formed to penetrate the second body 2310 downward from the top surface of the second body 2310. The second guide portion 2311 is configured to guide the second cutting member 2320 through its vertical movement as the second cutting member 2320 is inserted thereinto.

In other words, the second guide portion 2311 corresponds to a hole that is formed long in the longitudinal direction of the second body 2310.

In addition, the second body 2310 is further provided with a keyway 2312 configured to prevent the rotation of the second cutting member 2320 provided in the second body 2310.

The keyway 2312 is formed inside the second body 2310, and is preferably formed to be depressed inward from an inner ring formed by the second guide portion 2311.

The above-described keyway 2312 is formed long in the longitudinal direction of the second body 2310.

The second cutting member 2320 is provided inside the second body 2310.

The second cutting member 2320 is configured to enable the cutting of a workpiece using a gas. A second rack portion 2321 is formed on one surface of the second cutting member 2320 configured to allow the second cutting member 2320 to be transferred inside the second guide portion 2311 by the rotation of the second adjustment member 2330.

The second rack portion 2321 is formed to protrude from one surface of the second cutting member 2320. The second rack portion 2321 is configured to allow the second cutting member 2320 to be transferred along the second guide portion 2311 by the rotation of the second adjustment member 2330.

The second rack portion 2321 is formed to correspond to the keyway 2312. The above-described second rack portion 2321 is located inside the keyway 2312, so that it can prevent the second cutting member 2320 from being rotated inside the second guide portion 2311 while being transferred along the second guide portion 2311.

In addition, the second adjustment member 2330 is provided in the second body 2310.

The second adjustment member 2330 is provided to penetrate the second body 2310 from the front side of the second body 2310 to the back side thereof The second adjustment member 2330 is configured such that the front end thereof is implemented as a handle configured to allow rotation by a user and the back end thereof is implemented as a pinion configured to be coupled to the second rack portion 2321 and allow transfer along the second guide portion 2311.

In other words, according to the clockwise or counterclockwise rotation of the second adjustment member 2330, the second cutting member 2320 may be transferred along the inside of the second guide portion 2311.

The distance to a workpiece may be adjusted by the second cutting part 2300 configured as described above, and also the cutting of a workpiece may be performed.

In other words, the second cutting part 2300 enables the adjustment of the distance to a workpiece while enabling the adjustment of an angle with respect to the workpiece.

The first cutting means 1000 and second cutting means 2000 configured as described above may cut a workpiece through different cutting methods (a laser, and a gas). In this case, the first cutting means 1000 and the second cutting means 2000 cut a workpiece in complement to each other.

In more detail, the point at which laser machining is performed by the first cutting means 1000 is preferably located inside the point at which gas machining is performed by the second cutting means 2000.

The reason for this is that the cutting area of the gas cutting performed by the second cutting means 2000 is wider than the cutting area of the laser cutting performed by the first cutting means 1000 and the heat generated by the first cutting means 1000 is higher than the heat generated by the second cutting means 2000.

In other words, a workpiece may be melt with high heat in an area narrower than that in the case of the second cutting means 2000 at the point at which laser machining is performed by the first cutting means 1000. The second cutting means 2000 performs gas cutting along the point at which laser machining is performed and high heat is provided by the first cutting means 1000, thereby allowing heat to be concentrated around the point at which laser machining is performed.

In this case, the concentration of heat implies that the heating performed by the first cutting means 1000 and the heating performed by the second cutting means 2000 improve cutting efficiency by generating synergy.

The reason for this is that the heating performed by the second cutting means 2000 minimizes the diffusion of heat in the outward direction from the point at which laser machining is performed by the first cutting means 1000, so that heat is concentrated on the point at which laser machining is performed.

As described above, a workpiece is cut through the first cutting means 1000 and the second cutting means 2000, and thus a reduction in cutting time and a reduction in the number of kerfs can be achieved.

In addition, the gas used in the second cutting means 2000 is, e.g., hydrogen, oxygen, liquefied petroleum gas, or liquefied natural gas.

More specifically, the second cutting means 2000 is configured to enable the cutting of a workpiece using a gas. The gas may include a preheating gas for preheating a workpiece and a cutting gas for cutting a workpiece.

In this case, hydrogen fuel-oxygen gas is used as the preheating gas for preheating a workpiece, and oxygen gas is used as the cutting gas for cutting a workpiece.

As the hydrogen fuel-oxygen gas is used as the preheating gas for preheating a workpiece in the second cutting means 2000, cutting efficiency may be improved over the case where liquefied petroleum gas (LPG) or liquefied natural gas (LNG) is used.

It is obvious that liquefied natural gas-oxygen gas, liquefied petroleum gas-oxygen gas, or acetylene gas-oxygen gas may be used as the preheating gas for preheating a workpiece in the second cutting means 2000.

In other words, in the laser-gas hybrid cutting system according to the present invention, the first cutting means and the second cutting means are provided, and the first cutting means and the second cutting means cut a workpiece together, so that cutting efficiency can be improved.

Furthermore, in the laser-gas hybrid cutting system according to the present invention, the second cutting member constituting a part of the second cutting means is provided to enable the adjustment of an angle with respect to a workpiece and the distance to the workpiece, so that machining conditions optimized for the first cutting means and the second cutting means can be provided.

Moreover, in the laser-gas hybrid cutting system according to the present invention, the second cutting means uses hydrogen fuel-oxygen gas, so that cutting speed is improved and a reduction in the number of kerfs can be achieved.

The scope of the present invention is not limited to the embodiments illustrated above, and many other modifications may be made by those skilled in the art to which the present invention pertains within the technical scope of the present invention.

What is claimed is:

1. A laser-gas hybrid cutting system, comprising:
a first cutting means coupled to a gantry or arm, provided to be transferable, and configured to enable cutting of a workpiece using a laser; and
a second cutting means provided on one side of the first cutting means so that an angle or distance can be varied with respect to a workpiece, and configured to enable cutting of a workpiece using a gas together with the first cutting means;
wherein the gas used in the second cutting means is any one of hydrogen, oxygen, liquefied petroleum gas, and liquefied natural gas.

2. The laser-gas hybrid cutting system of claim 1, wherein the second cutting means comprises:
a first body provided to be spaced apart from the first cutting means to one side of the first cutting means;
a first guide part provided on one side of the first body, and configured to allow a second cutting part to be transferred along a radius of curvature thereof; and
the second cutting part provided to be transferable from one side of the first guide part to a remaining side of the first guide part, and configured to enable cutting of a workpiece using a gas.

3. The laser-gas hybrid cutting system of claim 2, wherein the first guide part comprises:
a first guide member provided on one side of the first body and provided with a first rack portion therein so that the first guide member can guide a first transfer member through its transfer;
the first transfer member provided on one side of the first guide member, and configured to be transferred along an inside of the first guide member by rotation of a first adjustment member; and
the first adjustment member provided on one side of the first transfer member and provided to be rotatable inside the first guide member so that the first transfer member can be transferred.

4. The laser-gas hybrid cutting system of claim 2, wherein the second cutting part comprises:
a second body provided on one side of the first transfer member, and provided with a second guide portion therein;
a second cutting member provided inside the second body and provided with a second rack portion on one surface thereof so that the second cutting member can be transferred along an inside of the second guide portion by rotation of a second adjustment member and enables cutting of a workpiece using a gas; and
the second adjustment member provided on one side of the second body and rotatably provided inside the second body so that it enables transfer of the second cutting member.

5. The laser-gas hybrid cutting system of claim 1, wherein a point at which laser machining is performed by the first cutting means is located inside a point at which gas machining is performed by the second cutting means.
